(19) United States
(12) Patent Application Publication
(10) Pub. No.: US 2025/0392781 A1
(43) Pub. Date: Dec. 25, 2025

(54) MODELING AND PERSONIFICATION IN A CLEANROOM

(71) Applicant: VIDEOAMP, INC., Los Angeles, CA (US)

(72) Inventors: Michael Ethan Hankin, San Francisco, CA (US); Amir Mohammadaghaei, San Diego, CA (US); Qi Liu, Mead, CO (US); Jack Haocheng Wang, Henderson, NV (US); James Robert Koehler, Boulder, CO (US); Adria Danielle Jewell, Marina del Rey, CA (US); Jordan Paul Salyards, Marshall, VA (US); Christopher Thomas Lemper, Boulder, CO (US); Ramzi Joseph Nasr, Cypress, CA (US); Nicholas E. Lavers, San Clemente, CA (US); Candice Jasmine Gonzalez Slay, Fairfax, VA (US)

(73) Assignee: VIDEOAMP, INC., Los Angeles, CA (US)

(21) Appl. No.: 19/246,467

(22) Filed: Jun. 23, 2025

Related U.S. Application Data
(60) Provisional application No. 63/663,013, filed on Jun. 21, 2024.

(51) Int. Cl. H04N 21/442; H04N 21/84

(52) U.S. Cl. CPC H04N 21/44204; H04N 21/84

(57) ABSTRACT

A method may include obtaining demographic data from multiple households in a cleanroom. The method may include obtaining viewership data associated with displayed content from one or more data sources in the cleanroom. The viewership data may be generated by at least a portion of the multiple households. The method may include generating demographic scores using the viewership data and the demographic data with respect to viewers in the multiple households. The method may include estimating a first count of the viewers and a second count of the viewers of the displayed content. The method may include determining an impression score using the demographic scores and the first count of the viewers. The method may include determining a reach score using the demographic scores and the second count of the viewers. The method may include providing the impression score and the reach score in the cleanroom to a requesting entity.

### CROSS REFERENCE TO RELATED APPLICATIONS

This U.S. Patent application claims priority to U.S. Provisional Patent Application No. 63/663,013, titled “MODELING AND PERSONIFICATION FOR ELECTRONIC MEDIA DISTRIBUTION,” and filed on Jun. 21, 2024, the disclosure of which is hereby incorporated by reference in its entirety.

### TECHNICAL FIELD

This disclosure relates to personification in a media measurement, and more specifically, to modeling and personification in a cleanroom.

### BACKGROUND

Unless otherwise indicated herein, the materials described herein are not prior art to the claims in the present application and are not admitted to be prior art by inclusion in this section.

Personification in a media measurement refers to a modeling technique of assigning household-level impressions and/or content viewership to one or more appropriate persons within the household. For example, a first person, a second person, and a third person may reside in a particular household, and in response to content being viewed in the household, personification may attribute an impression (associated with the content) with at least one of the first person, the second person, and/or the third person. By assigning the household-level impressions to an appropriate person within the household, an improved understanding of the impact and/or effectiveness of a media campaign may be determined. Alternatively, or additionally, communicating the impact and/or effectiveness may be improved when personification is implemented. A clean room may be a data storage environment configured for privacy (relative to the data stored therein) that may contain non-personified impressions.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

In an example embodiment, a method may include obtaining demographic data from multiple households in a cleanroom. The method may also include obtaining viewership data associated with displayed content from one or more data sources in the cleanroom. The viewership data may be generated by at least a portion of the multiple households. The method may further include generating demographic scores using the viewership data and the demographic data with respect to viewers in the multiple households. The method may also include estimating a first count of the viewers and a second count of the viewers of the displayed content. The method may further include determining an impression score using the demographic scores and the first count of the viewers. The method may also include determining a reach score using the demographic scores and the second count of the viewers. The method may further include providing the impression score and the reach score in the cleanroom to a requesting entity.

In another embodiment, a system may include one or more non-transitory computer-readable storage media configured to store instructions. The system may also include one or more processors communicatively coupled to the one or more non-transitory computer-readable storage media and configured to, in response to execution of the instructions, cause the system to perform operations. The operations may include obtaining demographic data from multiple households in a cleanroom. The operations may also include obtaining viewership data associated with displayed content from one or more data sources in the cleanroom. The viewership data may be generated by at least a portion of the multiple households. The operations may further include generating demographic scores using the viewership data and the demographic data with respect to viewers in the multiple households. The operations may also include estimating a first count of the viewers and a second count of the viewers of the displayed content. The operations may further include determining an impression score using the demographic scores and the first count of the viewers. The operations may also include determining a reach score using the demographic scores and the second count of the viewers. The operations may further include providing the impression score and the reach score in the cleanroom to a requesting entity.

The objects and advantages of the embodiments will be realized and achieved at least by the elements, features, and combinations particularly pointed out in the claims.

Both the foregoing general description and the following detailed description are given as examples and are explanatory and not restrictive of the invention, as claimed.

### DESCRIPTION OF DRAWINGS

Example implementations will be described and explained with additional specificity and detail using the accompanying drawings in which:

FIG. 1 illustrates a block diagram of an example system for modeling and personification in a cleanroom;

FIG. 2 illustrates a block diagram of an example flow for modeling and personification in a cleanroom;

FIG. 3 illustrates an example table that may be used with modeling and personification in a cleanroom;

FIG. 4 illustrates a flowchart of an example method of modeling and personification in a cleanroom; and

FIG. 5 illustrates an example computing device.

### DETAILED DESCRIPTION

Entities associated with content generation and/or distribution may seek to understand viewership of the content as it may be displayed in a household. The entities may be interested in obtaining viewership details including number of viewers of the content, how many times content may be displayed to reach a target number of viewers, and so forth. In some instances, obtaining viewership data may be generally limited to whether or not the content was displayed in a household, but it may be difficult to determine what kind of impressions and/or reach may be associated with the displayed content. Additionally, in some instances, it may be difficult to determine the amount of viewing associated with the content (even on a household level) as entities that may obtain the viewership data may be reluctant to share data, such as due to privacy concerns.

Aspects of the present disclosure describe a system and method where a cleanroom may be operable to obtain viewership data associated with displayed content in a household. Alternatively, or additionally, the cleanroom may obtain demographic data associated with the household, and the cleanroom may utilize one or more models to use both the demographic data and the viewership data (or estimated viewership data) to determine reach and/or impressions associated with the displayed content. The cleanroom may provide privacy protections to the data, such that access to the data and/or the resultant reach and/or impressions calculations may be restricted to entities that may have been granted access to the cleanroom.

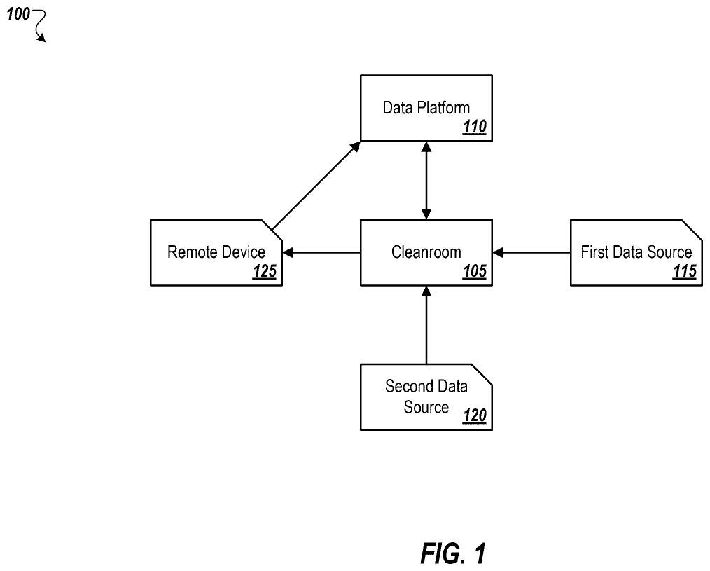

FIG. 1 illustrates a block diagram of an example system 100 for modeling and personification in a cleanroom. The system 100 may include a cleanroom 105 and a data platform 110. In some instances, the system 100 may be operable to build one or more models that may be used within the cleanroom 105 to attribute impressions and/or reach to viewers of displayed content while maintaining privacy for the underlying data associated with the viewers and/or metrics associated with the displayed content. In some instances, the displayed content may be delivered to the viewers in the form of linear programming, streaming programming, digital programming, and/or any other type of programming or combinations thereof. In some instances, the system 100 may be operable to provide

In some instances, the cleanroom 105 may be configured to act as a shared data space with restricted access. The cleanroom 105 may refer to an environment where some or all data may be anonymized, aggregated, processed, and/or stored to be made available for measurement, and/or data transformations in a privacy-focused way. For example, the first data source 115 and the second data source 120 may desire to share their respective data corpora with one another. The first data source 115 and the second data source 120 may then enter into a contract or agreement to share data. Responsive to receiving a request from the first data source 115 and the second data source 120 to create or join the cleanroom 105, the cleanroom 105 may be created and used by the first data source 115 and the second data source 120.

In some instances, the cleanroom 105 may be accessed using one or more of a service account and/or an encryption key. The cleanroom 105 may include some or all of the respective data corpora from both the first data source 115 and the second data source 120. Access to the cleanroom 105 may be restricted in any manner. In some examples, the access may be restricted using the service account. A service account may refer to a specific account that has been created for the purpose of accessing a particular shared data space. Additionally or alternatively, access to the cleanroom 105 may be restricted using the encryption key. The encryption key, for example, may limit access only to entities (e.g., the first data source 115 and the second data source 120) that may have entered into a contract with one another, and may be generated using any method of encryption for encrypting data. Further, an encryption key may only provide one-way access to the entities that have access to the key. The first data source 115 and the second data source 120 that have an encryption key and access to the cleanroom 105 may desire to have additional entities (e.g., other data sources) and their data corpora joined to the cleanroom 105. In such a scenario, a third data source (not illustrated) may be provided an encryption key that may grant access to the cleanroom 105 already created for use by the first data source 115 and the second data source 120. In some instances, the encryption key may be shared after permission is given by the entities (e.g., the first data source 115 and the second data source 120) that currently have access to the encryption key.

In some instances, the data platform 110 may be a computing device, system, and/or application that may be operable to interface with the cleanroom 105. In some instances, the data platform 110 may be operable to utilize the cleanroom 105 to bypass restrictions that may be included on individual level data (e.g., data belonging to an individual and not included in an aggregate). For example, operations may be performed by the data platform 110 within the cleanroom 105 (where data stored therein may be anonymized) and subsequently extracted in an aggregate form, thus maintaining the anonymity of the data within the cleanroom 105.

In some instances, the data platform 110 may obtain demographic data associated with households and the data platform 110 may be operable to transmit the household demographic data to the cleanroom 105. The demographic data may include a number of persons included in a household and/or a demographic subset (e.g., a gender and/or an age range) that may apply to each of the persons in the household. Alternatively, or additionally, the demographic data may be associated with persons in multiple households and/or may be grouped based on location of the multiple households. In some instances, the demographic data may include probabilities associated with the persons in the household to be a viewer of displayed content. For example, the demographic data may include a probability that a particular person in a household may be a viewer of particular displayed content based on one or more of a content type associated with the particular displayed content, a time of day associated with the particular displayed content, a channel associated with the particular displayed content, and/or other attributes associated with the particular displayed content including playback.

In some instances, the cleanroom 105 may obtain the demographic data from the data platform 110, as described, and/or the cleanroom 105 may obtain viewership data and/or associated metadata (referred to collectively as viewership data, unless indicated otherwise) from various sources, such as the first data source 115 and/or the second data source 115. In some instances, the viewership data may be obtained on a household level. For example, particular viewership data associated with particular displayed content may be attributed to a first household and not a second household. In these and other instances, the viewership data may be associated with multiple households (and/or individually attributed to multiple households) and may be provided by one or more data sources, such as the first data source 115 and/or the second data source 120.

In some instances, the cleanroom 105 may be operable to attribute the viewership of displayed content within a household to particular viewers within the household. For example, for a particular displayed content, the cleanroom 105 may be operable to determine a probability that a first person in the household viewed the particular displayed content. The cleanroom 105 may be operable to utilize the demographic data in conjunction with the viewership data to attribute impressions and/or reach associated with displayed content to particular viewers within a household.

In some instances, the cleanroom 105 may generate and/or train one or more models that may be used within the cleanroom 105 to attribute viewership of displayed content to particular viewers within a household, as described. In some instances, the cleanroom 105 may obtain training data that may be used to train the models. For example, the cleanroom 105 may obtain viewership training data from the first data source 115 and demographic training data from the data platform 110, and the cleanroom 105 may generate and/or train the models that may be used to attribute viewership of displayed content to particular viewers within a household. In another example, the data platform 110 may be operable to provide both the viewership training data and the demographic training data. Alternatively, or additionally, the models may be generated and/or trained without the cleanroom 105, such as by the data platform 110. For example, the data platform 110 may obtain the viewership training data and the demographic training data and the data platform 110 may generate and/or train the models, and the data platform 110 may be operable to transfer the models to the cleanroom 105 for use therein.

In some instances, inputs that may be used for training the models may include at least TV person-level training data, associated metadata, survey responses (e.g., from one or more households), and/or average audience data associated with particular displayed content. Outputs associated with training the models may include one or more models and/or post-model adjustments (which may include various scaling values that may be used with the outputs from the models). In some instances, the models may include one or more of a demographic score model, viewer estimate model, where the viewer estimate model may be configured to generate an estimate of viewers in a household without including guests and an estimate of viewers in a household including guests. The outputs from training the models may be in the form of a text dump of gradient boosted tree models, such that the outputs may be human reviewable which may facilitate a transition into the cleanroom 105.

In some instances, processing that may be performed after the personification performed by the models in the cleanroom 105, as described, may be performed within or without the cleanroom 105, regardless of where the generation, training, or model operation may be performed. For example, in some instances, the models may be generated and/or training without the cleanroom 105, such as by the data platform 110. Personification may then be performed within the cleanroom 105 and post-processing (e.g., scaling or other manipulation to the personified data) may be performed within the cleanroom 105. Alternatively, or additionally, the personified data may be transmitted out of the cleanroom 105 (e.g., to the data platform 110) where post-processing may be performed without the cleanroom 105.

In some instances, a first model of the models within the cleanroom 105 may be operable to generate demographic scores associated with the viewers in a household. For example, the first model in the cleanroom 105 may be operable to utilize the demographic data and/or the viewership data associated with displayed content in a particular household to generate a demographic score for each person within the household. Alternatively, or additionally, a second model of the models within the cleanroom 105 may be operable to generate an estimate of viewers within a household for displayed content in the household. For example, the second model in the cleanroom 105 may be operable to utilize the demographic data and/or the viewership data associated with displayed content in a particular household to estimate a first count of the viewers of the displayed content in the household and estimate a second count of the viewers of the displayed content in the household. The first count may be an estimate of a total number of viewers associated with the household, which may include members of the household and/or guests at the household that may also view the displayed content. The second count may be an estimate of the viewers of the displayed content in the household without guests included (e.g., viewers may be the persons in the household).

In some instances, the models within the cleanroom 105 may be operable to assign probabilities of viewing to different viewers of displayed content in a particular household. The displayed content may include content viewed (e.g., a program), ad impressions associated with the content, any other media associated with the content or ad impressions, and/or any data associated with the content, any of which may be stored in the cleanroom 105. In some instances, the models may have access to anonymous information about the persons present in the particular household (e.g., age demographics, gender demographics, ethnicity, etc.) and/or knowledge of an affinity of the different persons with demographics to view particular content. By performing such personification in the cleanroom 105, at least the first data source 115 and/or the second data source 120 may be operable to share viewing data (e.g., viewership logs) therein (which may be otherwise unshareable due to privacy issues) and/or metadata (e.g., contextual information) about the viewing data. For example, the metadata associated with any displayed content may include a genre, title, rating, and/or other details and/or characteristics associated with the displayed content.

In some instances, the models within the cleanroom 105 (e.g., that may have been trained as described herein) may be operable to obtain the viewership data (which may be at the household-level) and/or the demographic data. The models within the cleanroom 105 may be operable to output an estimate of person-level viewership associated with the displayed content in one or more households. The output from the models may include an expected number of impressions per person, may be grouped by demographic, and/or may include an estimated score based on the in-home reach of the displayed content.

In some instances, the cleanroom 105 may be operable to enable transparency for the first data source 115 and/or the second data source 120 as to which model may be operating on their respective contributed data before the results of the models in the cleanroom 105 may be reported at the person-level, such as to a remote device 125, as described herein. Alternatively, or additionally, a particular data source (e.g., the first data source 115) may allow a model of other data sources (e.g., the second data source 120) to use metadata of their displayed content in other models, which may increase the collective accuracy of the models within the cleanroom 105.

In some instances, the remote device 125 may be operable to request impression-level data and/or reach-level data associated with the displayed content from the cleanroom 105. For example, after the impression score and/or the reach score may be determined within the cleanroom 105, the remote device 125 may obtain the impression score and/or the reach score from the cleanroom 105. In some instances, the remote device 125 may obtain permission to access the cleanroom 105, such as by obtaining an encryption key, as described herein. In such instances, access to the data (e.g., the impression score, the reach score, etc.) may be limited and/or restricted, such as by the first data source 115, the second data source 120, and/or any limitations that may be included in the cleanroom 105. For example, the remote device 125 may request data associated with first displayed content and second displayed content. In response to the request from the remote device 125 and from a restriction from the first data source 115 relative to the second displayed content, the cleanroom 105 may provide the data associated with the first displayed content to the remote device 125 and the cleanroom 105 may withhold the data associated with the second displayed content to the remote device 125.

Modifications, additions, or omissions may be made to the system 100 without departing from the scope of the present disclosure. For example, the designations of different elements in the manner described is meant to help explain concepts described herein and is not limiting. Further, the system 100 may include any number of other elements or may be implemented within other systems or contexts than those described. For example, any of the components of FIG. 1 may be divided into additional or combined into fewer components.

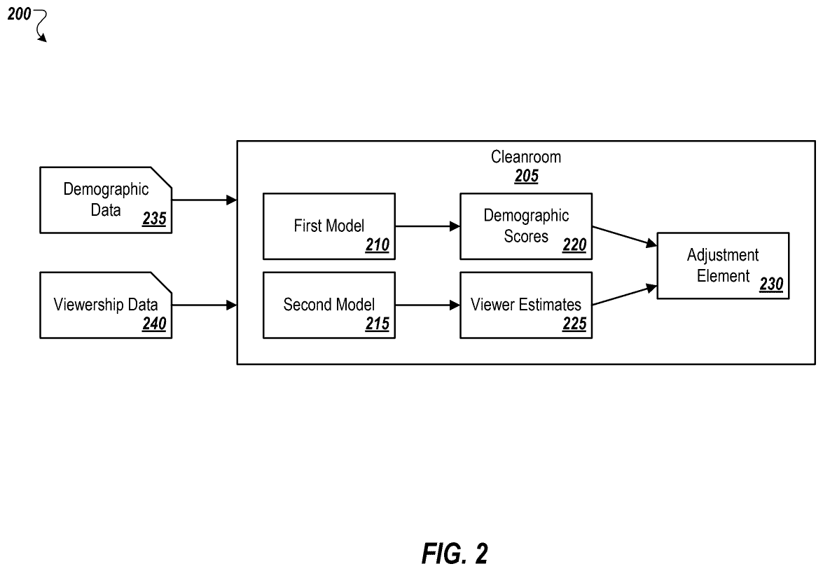

FIG. 2 illustrates a block diagram of an example flow 200 for modeling and personification in a cleanroom 205. The cleanroom 205 may include a first model 210, a second model 215, demographic scores 220, viewer estimates 225, and an adjustment element 230.

In some instances, the cleanroom 205 may obtain demographic data 235 and/or viewership data 240 from one or more data sources outside the cleanroom 205, as described herein. For example, the demographic data 235 may be obtained by the cleanroom 205 from a data platform, such as the data platform 110 of FIG. 1. In another example, the viewership data 240 may be obtained by the cleanroom 205 from a first data source and/or a second data source, such as the first data source 115 and/or the second data source 120 of FIG. 1.

In some instances, the first model 210 and/or the second model 215 may be gradient boosted tree models. In some instances, the first model 210 may use a logistic loss objective function and weights that may be implemented in the first model 210 may be based on a household weight multiplied by some function of viewership session length (ex: minutes watched/15 for sessions under 15 minutes, and 1 for sessions over 15 minutes). In some instances, the second model 215 may use a standard set of gradient boosting machine hyperparameters for regularization on the log number of total viewers. Alternatively, or additionally, other models may be utilized. For example, a 0-censored Poisson model or a 1-shifted Poisson model may be used.

The first model 210 may be operable to generate the demographic scores 220. In some instances, the first model 210 may use the demographic data 235 and/or the viewership data 240 associated with displayed content to obtain person level viewership scores. In some instances, the person level viewership scores determined by the first model 210 may be applicable to big screen devices and/or small screen devices. In some instances, the small screen devices may include person-level data (e.g., as a small screen device may be attributed to a single person) and in instances in which big screen devices are used by the first model 210, the impressions sourced from the big screen device may be person-level data (e.g., a particular person may be identified with the impressions on the big screen device).

In some instances, a big screen device may refer to devices having a size similar to a normal or conventional TV, which may be a device conventionally intended for or located in a household and where one or more people in the household may consume content together. For example, a connected TV (CTV) or a set-top box (STB) may be a big screen device. Alternatively, or additionally, a big screen device may also include larger screens including movie theaters, billboards, etc. In some instances, a small screen device may include any devices for consuming content that are not big screen devices. For example, small screen devices may include, but not be limited to, mobile phones, tablets, desktop computers, and/or other devices not considered a big screen device.

In some instances, the demographic scores 220 may represent a probability of viewership of displayed content in a household, for each member of the household. In some instances, counting total impressions and/or reach associated with displayed content in the household may include scaling the demographic scores 220 such that the sum thereof for the household members may be substantially similar to the viewer estimates 225 from the second model 215.

In some instances, the demographic scores 220 may be scaled to sum to the viewer estimates 225 that may include guests in the estimate. Alternatively, or additionally, in some instances, the demographic scores 220 may include a second, scaled demographic score where the sum of the demographic scores 220 for a particular household viewing session may be scaled such that the demographic scores 220 may be at least one. The scaled demographic scores 220 may be used to compute linear reach, as described herein.

Alternatively, or additionally, a second, scaled demographic score may be produced as part of the demographic scores 220, where a sum of the demographic scores 220 for a particular household viewing session may be scaled so that the sum of the demographic scores 220 is at least one. The demographic scores 220 may be applied separately for digital content and/or linear content via a scores table and a user defined function, respectively. In some instances, the second, scaled demographic score (and/or multiple second, scaled demographic scores) may be combined to compute a total reach, which may be determined by applying a reach user defined function to produce a distribution over frequency of exposure for a particular person in the media campaign. In some instances, the distributions over exposures may be summed for each demographic subset.

In some instances, the scaling of the demographic scores 220 may be performed by applying a reach user defined function to produce a distribution over frequency of exposure for the particular person in the media campaign. In some instances, the distributions may be summed over exposures for each demographic subset and/or the total impressions with guests for the same demographic subset may be computed. Using the summed frequency distribution, the total number of impressions that may be implied may be calculated. Alternatively, or additionally, the summed frequency distribution may be scaled to match the total impression with guests for the same demographic subset.

To determine reach (or a reach score) of the displayed content, the demographic scores 220 may be preserved as a probability such that reach scores may be less than or equal to one. To accomplish such, the demographic scores 220 may be scaled by a reach factor (e.g., by the adjustment element 230), which may be the lesser of: one divided by a maximum demographic score of the demographic scores 220 or . . . a first count of the viewer estimates 225 (e.g., an estimate of the number of persons within a household not including household guests) divided by a sum of the demographic scores 220. In instances in which the latter calculation causes an adjusted score to be greater than one, the former calculation may be utilized.

To determine impressions (or an impression score) of the displayed content (which may not be interpretable as probabilities), the demographic scores 220 may be scaled by an impression factor (e.g., by the adjustment element 230). In some instances, the impression score may be indicative of a number of people (that may be grouped by a demographic subset and/or which may or may not include guests in the household) that may be exposed to displayed content during a viewing session. The impression factor may be determined by estimating a second count of the viewer estimates 225 (e.g., an estimate of the number of persons within a household including household guests) and dividing the second count by the sum of the demographic scores 220. The impression score may be of any value, including greater than one, as the impression score may not be a probability limited to a value between zero and one. In some instances, the impression scores may be aggregated at a campaign level and/or at a demographic subset level.

In instances in which a small screen device is used to provide the data to the cleanroom 205 (and/or the models within the cleanroom 205), the first model (e.g., associated with generating the demographic scores 220) may be applied for small screen device impressions and the second model 215 (e.g., associated with generating the viewer estimates 225) may not be used as an assumption that the small screen device may be less accessible to multiple persons and/or guests may be implemented. After obtaining the demographic scores 220, the demographic scores may be normalized such that the sum of all scores may be equal to one.

In some instances, such as when cross screen content may be considered, the demographic scores 220 may be scaled to sum to the total viewer estimates 225 (e.g., the viewer estimate including guests) for a particular household viewing session, which may be termed scaled-for-impression demographic score. Alternatively, or additionally, a second, scaled demographic score may be generated, where the sum of demographic scores for a particular household viewing session may be multiplied by the lesser of (1/max (raw score in a household session), total viewer estimates 225/sum of the demographic scores 220 for the household), which may be referred to as the scaled-for-reach demographic score. As such, the sum of the scaled-for-reach demographic scores for a household session may equal the lessor of (sum of the demographic scores 220, total viewer estimates 225). The scaled-for-reach demographic score may be used for reach calculations as described and/or the scaled-for-impression demographic score may be used for impression calculations, as described.

In some instances, one or more dependencies may be associated with the operations that may be performed in the cleanroom 205, as described. The dependencies may be used as part of the personification operation as described herein, and/or may be determined or obtained without the cleanroom 205 and/or stored in the cleanroom 205. For example, a household average audience (e.g., for live displayed content and/or live plus same day displayed content) may be precalculated, and/or percentages of total viewership of the displayed content may be precalculated. In another example, an exploded person-level possible view event may be obtained, where the exploded person-level view may be precalculated and/or may be obtained on-the-fly. The exploded person-level view may include determining any possible combination of viewers in a particular household for displayed content therein, and using the determined combinations obtain an estimate of viewership for the displayed content. In another example, a program identifier to genre mapping may be obtained by the cleanroom 205 and/or a listing of Spanish channels may be obtained. In another example, an external training script may be available. In another example, raw viewership data and/or daily person weights may be obtained from a third-party to be used in determining the impression scores and/or the reach scores, as described. In another example, a sample of some data may be available to compare joint feature distributions by channel against other data to determine a multiplier for a particular device in the household and/or when a particular language may be used in the household (e.g., Spanish). Stated another way, viewership associated with a first channel (e.g., a Spanish language channel) may be compared to viewership associated with a second channel (e.g., a weather channel), such that characteristics of the channel associated with displayed content in the household may be used as a dependency in the personification process.

In some instances, the personification algorithm, as described, may include a data platform (e.g., the data platform 110 of FIG. 1) obtaining viewership data and/or demographic data. The data platform may be operable to develop a set of training data that may be used to train the first model 210 and/or the second model 215 (e.g., depending on the type of training data developed by the data platform). In some instances, the training data may be used to train the models as described herein, which may include at different stages of use of the models. For example, the training data may be used to initially train the models before deploying the models for use; the training data may be used to adjust the models as the models are used to make inferences associated with personification (e.g., as the models are deployed); and the training data may be used to update the models and/or associated elements operable to perform post-model adjustments, such as scaling scores and/or estimates as described herein.

In some instances, the training data may be stored in memory associated with the data platform and/or the cleanroom 205. The training data may be used to train one or more machine learning models (e.g., the first model 210 and/or the second model 215), such as a light gradient-boosting machine learning model. In some instances, the machine learning models may be prepared as text and the text may be exported into the cleanroom 205, and in some instances, the machine learning model text may be exported in stages. In some instances, the machine learning models may be loaded into a user defined function (e.g., Python) and may be used to generate scores for person-level viewing of the displayed content. Alternatively, or additionally, the models may be trained in the cleanroom 205 and/or stored via a model registry, where the models may be used from the model registry, such as with a user defined function providing post-processing.

In some instances, the training data may be generated using a number of steps. First, viewing data may be obtained. Second, the viewing data may be enriched with airing program attributes, which airing attributes may include genres, program duration, household-level features, etc. Third, program share and/or program same-day average audience attributes may be added to the training dataset, which may further enrich the airing program attributes. Fourth, the training dataset may be processed into person-level training data and/or may be processed into household viewership session-level training data.

The described steps may result in an assembled training dataset. Each row in the training dataset may represent a particular person's viewing session (either actually happened or possibly happened, as indicated by the target value). Alternatively, or additionally, the viewing session may include rich features, such as program dayparts, playback dayparts, program genres, household demographics, and/or person demographics including age, gender, etc.

The second model 215 may be operable to generate the viewer estimates 225 as described. In some instances, the second model 215 may be operable to generate at least two different viewer estimates 225, where a first count of the viewer estimates 225 may include persons included in the household but not include potential guests that may be present in the household, and a second count of the viewer estimates 225 may include persons in the household and guests that potentially may be in the household. In some instances, the first count may be determined using the viewership data 240 associated with household-level data (e.g., impressions in the viewership data 240 may be limited to a household-level) and may or may not include person-level data. Alternatively, or additionally, the second count of the viewer estimates 225 may be determined using the viewership data 240 associated with household-level data.

In some instances, the first model 210 may be operable to generate the demographic scores 220 and the second model 215 may be operable to generate the viewer estimates 225. The demographic scores 220 and the viewer estimates 225 may be used to determine an impression score and/or a reach score for each person-level view of displayed content (e.g., for each household view of the displayed content, and/or for each person included in the household). In some instances, the viewer estimates 225 may be obtained over a particular period of time, such as approximately two weeks.

The impression score may include a number of people of a particular demographic subset (which may or may not include guests in the household) that may be expected to be exposed to particular displayed content in the household. In some instances, the value of the impression score may be any value (e.g., the impression score may not be a probability, such that the value thereof may exceed one). The reach score may be a probability that may indicate a likelihood that a particular person may be exposed in the household to the displayed content (e.g., the reach score may be a probability, such that the value thereof may be between zero and one).

In some instances, the adjustment element 230 may be utilized within the cleanroom 205 to apply scalars and/or multipliers to the impression scores and/or the reach scores. For example, in some instances, a language multiplier and/or a toddler multiplier may be utilized to adjust the impression score and/or the reach score in view of a likely audience of the displayed content (e.g., a particular demographic associated with the language and/or a particular demographic subset (a toddler) associated with the displayed content). In some instances, outputs from the adjustment element 230 may include at least person-scaled impression scores and/or reach scores based on a particular language network (e.g., Spanish language networks) and/or person scaling based on displayed content (e.g., toddler content). In some instances, the adjustment element 230 may implement one or more scalars, which may emphasize or deemphasize aspects of the viewership data. For example, one or more rows of viewership data (e.g., that may be associated with one or more particular viewers of a household) may be scaled for a particular viewing device in the household such that the viewing distributions may be realigned.

In some instances, viewership behavior associated with one or more viewers in a household may vary over time. As such, the first model 210 and/or the second model 215 described herein may be retrained on a regular interval, such as a periodic interval. For example, the first model 210 and/or the second model 215 may be retrained on a lagging 12-18 month span (which may include incorporating additional data sources). Additionally, the first model 210 and/or the second model 215 may include seasonality features to account for seasonal trends that may be associated with some viewership.

In some instances, the personification algorithm described herein may be adjusted based on one or more circumstances associated with viewing the displayed content. For example, some scenarios may benefit from using a household average audience, such as instances in which it may be determined that the household has an interest in particular sports. For example, given a moderate interest regular season NFL game or an NCAA basketball game may include similar inference time features as the Super Bowl or a collegiate playoff game, respectively, those two classes of event may experience very different viewers per viewing household numbers. In such instances, household average audience based signals (that may serve as a proxy for overall interest) may be implemented that may influence the models.

A first adjustment may include obtaining a log of the live audience plus same day household average audience according to a panel for the event (e.g., the displayed content). A second adjustment may include obtaining a calculation of the share of viewership at the time the event aired and attributed to the event. In such instances, refactoring of the performance of personification may be performed, such that household average audience statistics may be precomputed and/or a scoring function that permits continuous features may be included.

Modifications, additions, or omissions may be made to the flow 200 without departing from the scope of the present disclosure. For example, in instances in which a personified product may not deliver a desired campaign reach, the personification implementation may involve a lazy extract, transform, load element in the cleanroom 205, wherein one or more events may go through the personification implementation once requested. Alternatively, or additionally, in instances in which a particular viewing event may have gone through a personification implementation, the personified records (e.g., the demographic scores 220, the viewer estimates 225, the impression score, and/or the reach score) may be stored in a personified viewership table. In these and other instances, the demographic scores 220 (e.g., that may be unscaled, or otherwise unaltered) may be stored and/or the viewer estimates 225 may be stored in the personified viewership table. Alternatively, or additionally, when determining campaign reach, an existing reach and frequency methodology may be applied to the demographic scores 220. In some instances, an extrapolation element may be included in the cleanroom 205 and may be applied to the reach and frequency table using the viewer estimates 225 (e.g., the total number of viewers including guests) as the source impression count. The source impression count (or source impressions) may refer to the total count of impression from device logs, as for digital event data, impressions logged from each device may be recorded.

In some instances, a demographic scoring look-up table may be operable to be used with a household look-up table, such that the demographic scoring look-up table and the household look-up table may be utilized to determine separate viewer estimates 225 and household member average audience. In some instances, the adjustment element 230 may be operable to select the larger result of the sum of the demographic scores 220 and the viewer estimates 225 including guests. In some instances, an additional household average audience metric may be determined and/or used with the personification implementation described herein. The additional household average audience metric may be determined by the (log (household average audience) minus the average log (household average audience over the past year for the given network and daypart) divided by the (standard deviation of log (household average audience over the past year for the given network and daypart). Alternatively, or additionally, in some instances, the flow 200 may be performed without household average audience metrics being determined. In some instances, the second model 215 may be operable to generate the viewer estimates 225, which may include a first count of an estimated number of viewers associated with the household not including guests, and a second count of an estimated number of guest viewers associated with the household. Alternatively, or additionally, the flow 200 may include a third model (not illustrated) that may be operable to determine an estimate for a number of guest viewers in the household.

In another example, the designations of different elements in the manner described is meant to help explain concepts described herein and is not limiting. Further, the flow 200 may include any number of other elements or may be implemented within other systems or contexts than those described. For example, any of the components of FIG. 2 may be divided into additional or combined into fewer components.

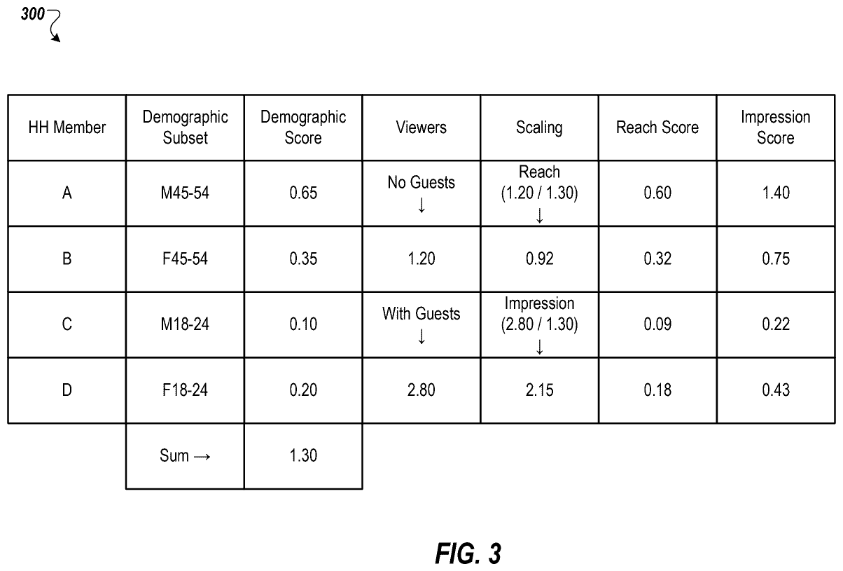

FIG. 3 illustrates an example table 300 that may be used with modeling and personification in a cleanroom. As illustrated, the table 300 may include a number of rows and columns that may include viewing data associated with a household and/or viewers associated with the household. As illustrated, the table 300 may include multiple different viewers, and each of the viewers may be identified by a demographic subset that the viewers may belong to. As described herein, a first model may be operable to determine a demographic score for each of the viewers in the household for displayed content in the household. Alternatively, or additionally, a second model may be operable to determine an estimate for the number of viewers in the household, which may include an estimate with guests and without guests. In some instances, the table 200 may include a scaling factor for reach and/or for impressions that may be determined using a sum of the demographic scores and the different viewer estimates, as described herein. The scaling factors may be applied to the demographic scores and the combinations thereof may yield the reach scores and/or the impressions scores.

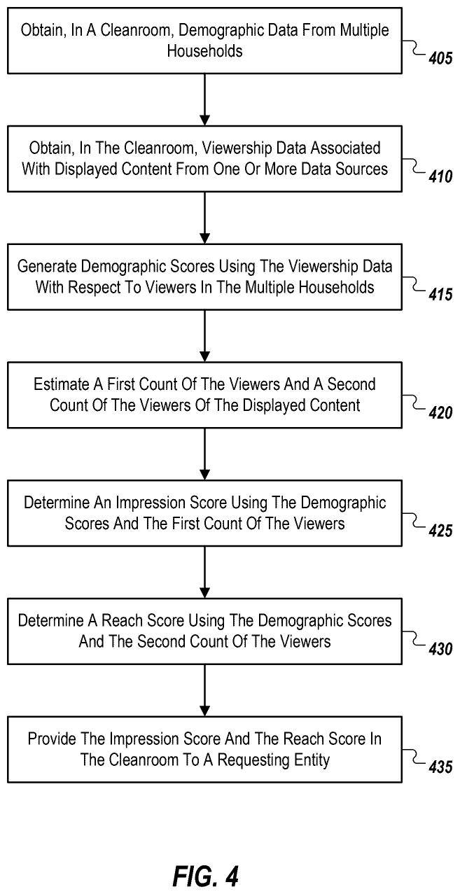

FIG. 4 illustrates a flowchart of an example method 400 of outcome measurement in a cleanroom. The method 400 may be performed by processing logic that may include hardware (circuitry, dedicated logic, etc.), software (such as is run on a general purpose computer system or a dedicated machine), or a combination of both, which processing logic may be included in any computer system or device, such as the cleanroom 105 or the data platform 110 of FIG. 1.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At block 405, demographic data from multiple households may be obtained in a cleanroom.

At block 410, viewership data associated with displayed content from one or more data sources may be obtained in the cleanroom. In some instances, the viewership data may be generated by at least a portion of the multiple households. In some instances, the viewership data may include at least viewing logs of the displayed content, metadata associated with the displayed content, and/or device type associated with the viewing of the displayed content. Alternatively, or additionally, the metadata may include at least one of genre, title, rating, language, release date, cast, director, and description.

At block 415, demographic scores may be generated using the viewership data and the demographic data with respect to viewers in the multiple households.

At block 420, a first count of the viewers and a second count of the viewers of the displayed content may be estimated. In some instances, the first count may be a first estimate of the viewers not including household guests and the second count may be a second estimate of the viewers that includes household guests.

At block 425, an impression score may be determined using the demographic scores and the first count of the viewers. In some instances, the impression score may be determined by calculating an impression scale factor using an aggregation of the demographic scores and the first count of the viewers, and applying the impression scale factor to a particular demographic of the demographic scores to obtain the impression score for the particular demographic.

At block 430, a reach score may be determined using the demographic scores and the second count of the viewers. In some instances, the reach score may be an adjusted probability that a particular viewer of the viewers viewed the displayed content. Alternatively, or additionally, the reach score may be individually determined for each demographic subset of the viewers. In some instances, the reach score may be determined by calculating a reach scale factor using the aggregation of the demographic scores and the second count of the viewers, and applying the reach scale factor to the particular demographic to obtain the reach score for the particular demographic.

At block 435, the impression score and the reach score in the cleanroom may be provided to a requesting entity. In some instances, the requesting entity may be a data source of the one or more data sources.

Modifications, additions, or omissions may be made to the method 400 as described without departing from the scope of the present disclosure. For example, in some instances, viewership training data and demographic training data may be obtained, and a first model and a second model may be trained using the viewership training data and the demographic training data. In some instances, the first model may be trained within the cleanroom and may be used to generate the demographic scores. In some instances, the second model may be trained without the cleanroom and may be used to estimate the first count of the viewers and the second count of the viewers. Alternatively, or additionally, in response to an external stimulus, the first model and/or the second model may be updated. In some instances, the external stimulus may include a change in season, a change in viewing behavior associated with the viewers, and a new data source. Further, the method 400 may include any number of other elements or may be implemented within other systems or contexts than those described.

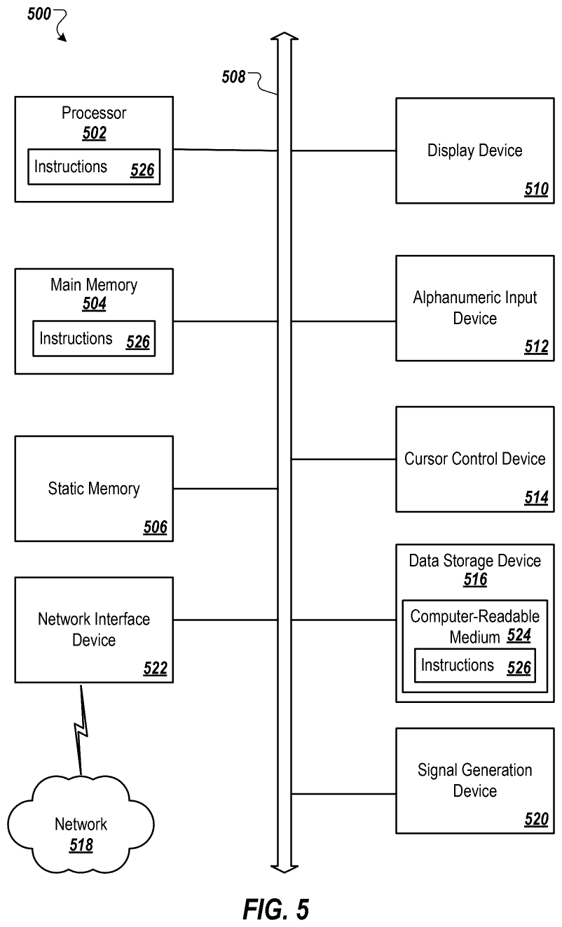

FIG. 5 illustrates an example computing device 500 within which a set of instructions for causing the machine to perform any one or more of the methods discussed herein may be executed. The computing device 500 may include a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions for causing the machine to perform any one or more of the methods discussed herein may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The computing device 500 can include a processing device 502 (e.g., a processor), a main memory 504 (e.g., read-only memory (ROM), flash memory, dynamic random access memory (DRAM) such as synchronous DRAM (SDRAM)), a static memory 506 (e.g., flash memory, static random access memory (SRAM)) and a data storage device 516, which communicate with each other via a bus 508.

The processing device 502 represents one or more general-purpose processing devices such as a microprocessor, central processing unit, or the like. More particularly, the processing device 502 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 502 may also include one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein.

The computing device 500 may further include a network interface device 522 which may communicate with a network 518. The computing device 500 also may include a display device 510 (e.g., a liquid crystal display (LCD) or a cathode ray tube (CRT)), an alphanumeric input device 512 (e.g., a keyboard), a cursor control device 514 (e.g., a mouse) and a signal generation device 520 (e.g., a speaker). In at least one implementation, the display device 510, the alphanumeric input device 512, and the cursor control device 514 may be combined into a single component or device (e.g., an LCD touch screen).

The data storage device 516 may include a computer-readable storage medium 524 on which is stored one or more sets of instructions 526 embodying any one or more of the methods or functions described herein. The instructions 526 may also reside, completely or at least partially, within the main memory 504 and/or within the processing device 502 during execution thereof by the computing device 500, the main memory 504 and the processing device 502 also constituting computer-readable media. The instructions may further be transmitted or received over the network 518 via the network interface device 522.

While the computer-readable storage medium 524 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding, or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

A number of implementations have been described. Nevertheless, it will be understood that various modifications may be made without departing from the spirit and scope of the disclosure. Accordingly, other implementations are within the scope of the following claims.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method comprising:
obtaining, in a cleanroom, demographic data from a plurality of households;
obtaining, in the cleanroom, viewership data associated with displayed content from one or more data sources, where the viewership data is generated by at least a portion of the plurality of households;
generating demographic scores using the viewership data and the demographic data with respect to viewers in the plurality of households;
estimating a first count of the viewers and a second count of the viewers of the displayed content;
determining an impression score using the demographic scores and the first count of the viewers;
determining a reach score using the demographic scores and the second count of the viewers; and
providing the impression score and the reach score in the cleanroom to a requesting entity.

2. The method of claim 1, further comprising:
obtaining viewership training data and demographic training data; and
training a first model and a second model using the viewership training data and the demographic training data.

3. The method of claim 2, wherein:
the first model is trained within the cleanroom and is used to generate the demographic scores; and
the second model is trained without the cleanroom and is used to estimate the first count of the viewers and the second count of the viewers.

4. The method of claim 2, further comprising in response to an external stimulus, updating the first model and the second model.

5. The method of claim 4, wherein the external stimulus is at least one of a change in season, a change in viewing behavior associated with the viewers, and a new data source.

6. The method of claim 1, wherein the viewership data comprises at least viewing logs of the displayed content, metadata associated with the displayed content, and device type associated with the viewing of the displayed content.

7. The method of claim 6, wherein the metadata comprises at least one of genre, title, rating, language, release date, cast, director, and description.

8. The method of claim 1, wherein the first count is a first estimate of the viewers not including household guests and the second count is a second estimate of the viewers that includes household guests.

9. The method of claim 1, wherein:
the reach score is an adjusted probability that a particular viewer of the viewers viewed the displayed content; and
the reach score is individually determined for each demographic subset of the viewers.

10. The method of claim 1, wherein the requesting entity is a data source of the one or more data sources.

11. The method of claim 1, wherein:
the impression score is determined by:
calculating an impression scale factor using an aggregation of the demographic scores and the first count of the viewers; and
applying the impression scale factor to a particular demographic of the demographic scores to obtain the impression score for the particular demographic; and
the reach score is determined by:
calculating a reach scale factor using the aggregation of the demographic scores and the second count of the viewers; and
applying the reach scale factor to the particular demographic to obtain the reach score for the particular demographic.

12. A system, comprising:
one or more non-transitory computer-readable storage media configured to store instructions; and
one or more processors communicatively coupled to the one or more non-transitory computer-readable storage media and configured to, in response to execution of the instructions, cause the system to perform operations, the operations comprising:
obtain, in a cleanroom, demographic data from a plurality of households;
obtain, in the cleanroom, viewership data associated with displayed content from one or more data sources, where the viewership data is generated by at least a portion of the plurality of households;
generate demographic scores using the viewership data and the demographic data with respect to viewers in the plurality of households;
estimate a first count of the viewers and a second count of the viewers of the displayed content;
determine an impression score using the demographic scores and the first count of the viewers;
determine a reach score using the demographic scores and the second count of the viewers; and
provide the impression score and the reach score in the cleanroom to a requesting entity.

13. The system of claim 12, wherein the operations further comprise:
obtain viewership training data and demographic training data; and
train a first model and a second model using the viewership training data and the demographic training data.

14. The system of claim 13, wherein:
the first model is trained within the cleanroom and is used to generate the demographic scores; and
the second model is trained without the cleanroom and is used to estimate the first count of the viewers and the second count of the viewers.

15. The system of claim 13, further comprising in response to an external stimulus, updating the first model and the second model.

16. The system of claim 15, wherein the external stimulus is at least one of a change in season, a change in viewing behavior associated with the viewers, and a new data source.

17. The system of claim 12, wherein the viewership data comprises at least viewing logs of the displayed content, metadata associated with the displayed content, and device type associated with the viewing of the displayed content.

18. The system of claim 17, wherein the metadata comprises at least one of genre, title, rating, language, release date, cast, director, and description.

19. The system of claim 12, wherein:
the reach score is an adjusted probability that a particular viewer of the viewers viewed the displayed content; and
the reach score is individually determined for each demographic subset of the viewers.

20. The system of claim 12, wherein:
the impression score is determined by:
calculating an impression scale factor using an aggregation of the demographic scores and the first count of the viewers; and
applying the impression scale factor to a particular demographic of the demographic scores to obtain the impression score for the particular demographic; and
the reach score is determined by:
calculating a reach scale factor using the aggregation of the demographic scores and the second count of the viewers; and
applying the reach scale factor to the particular demographic to obtain the reach score for the particular demographic.
